(19) United States
(12) Patent Application Publication
(10) Pub. No.: US 2003/0031337 A1
(43) Pub. Date: Feb. 13, 2003

(54) Loudspeaker with a three-dimensional diaphragm

(76) Inventor: Guido Odilon Maurits D'Hoogh, Dendermonde (BE)

Correspondence Address: U.S. Philips Corporation, 580 White Plains Road, Tarrytown, NY, 10591, US

(21) Appl. No.: 10/213,403

(22) Filed: Aug. 6, 2002

(30) Foreign Application Priority Data
Aug. 10, 2001 (EP) 01203057.3

(51) Int. Cl. H04R 1/00; H04R 9/06; H04R 11/02

(52) U.S. Cl. 381/396; 381/398; 381/433

(57) ABSTRACT

An electrodynamic loudspeaker comprising a chassis (2), a three-dimensional diaphragm (8) and an electromagnetic actuator (6). The diaphragm is connected to the chassis by a first flexible connecting means (18) provided near a front part (8a) of the diaphragm and by a second flexible connecting means (20) provided near a back part (8b) of the diaphragm. The actuator includes a stationary actuator element (6a) fixed to the chassis and a translatable actuator element (6b) fixed to the diaphragm. When energized, both actuator elements magnetically co-operate with one another over an air gap (16). In order to realize a flat but powerful speaker, the device as such and the air gap are outside the area (26) enclosed by the diaphragm but within the space (24) between both connecting means.

The invention relates to an electrodynamic loudspeaker comprising a chassis, a translatable body with a three-dimensional diaphragm extending within the chassis, comprising a front part and a back part, and an electromagnetic actuator for displacing said body with respect to the chassis along a translation axis extending from said one part to said other part of the diaphragm, said actuator comprising a stationary actuator element fixed to the chassis and a translatable actuator element connected to the translatable body proximate to the back part of the diaphragm, said actuator elements being capable of magnetically cooperating with each other over an air gap, while a first flexible connecting means is present proximate to the front part of the diaphragm for movably journaling the translatable body with respect to the chassis, and a second flexible connecting means is present proximate to the back part of the diaphragm for movably journaling the translatable body with respect to the chassis.

A dynamic loudspeaker comprising a conical diaphragm, a loudspeaker housing with a loudspeaker basket and an electromagnetic driver is known from DE-U 75 02 568. The driver is accommodated in the housing, outside the diaphragm, and has a driving coil arranged on a coil former secured to the diaphragm, as well as a magnetic system secured to the loudspeaker basket. The diaphragm which is within the loudspeaker basket is fixed on its front side to the loudspeaker basket via a flexible suspension rim and on its rear side via a centering means. In the known loudspeaker, the driver is situated in an area outside the loudspeaker basket so that the loudspeaker has a relatively large axial dimension. This has the drawback that the depth of the housing in practical embodiments is relatively large with respect to the front dimensions of the loudspeaker. Consequently, the known loudspeaker occupies a relatively large space of the volume constituted by the housing, which leads to relatively high system resonances and thus to a relatively high lower limit of the frequency range associated with a given volume.

It is an object of the invention to provide a compact loudspeaker that can be subjected to a high load.

According to the invention, this object is achieved with the loudspeaker which is characterized in that the air gap which extends between the stationary actuator element and the translatable actuator element is present outside the space enclosed and defined by the contours of the diaphragm and within an area between the first flexible connecting means and the second flexible connecting means.

Due to the characteristic feature described above, the loudspeaker according to the invention has only a limited axial dimension in spite of its three-dimensional diaphragm, so that it has a small build-in depth. Such a loudspeaker built in a housing therefore occupies a comparatively small volume, resulting in a low system resonance. The loudspeaker according to the invention is therefore eminently suitable for use in subwoofer systems in which compact, shallow housings are desired. The diaphragm used preferably has a conical central portion.

It is to be noted that a loudspeaker is known from EP-A 0 806 883 in which the electromagnetic drive of the diaphragm is situated within the space enclosed and defined by the contours of the diaphragm. In such a “wafer” loudspeaker, the available space within the diaphragm is, however, too small to build a sufficiently powerful magnetic system which complies with the high load requirements. Apart from the available space, the thermal load of the magnetic material of the magnetic system is also a limiting factor in the loudspeaker type referred to. Notably with modem magnetic material such as neodymium-iron-boron alloys, the maximum allowable temperatures are relatively low. For these reasons, a loudspeaker of the type known from EP-A 0 806 883 is only suitable for loudspeaker systems having a relatively small power.

In a practical embodiment of the loudspeaker according to the invention, the stationary actuator element is at least largely and preferably completely present within a zone situated between the first flexible connecting means and the second flexible connecting means of the loudspeaker.

A preferred embodiment of the loudspeaker according to the invention is characterized in that the stationary actuator element comprises an annular permanent magnet, and the translatable actuator element comprises a magnet coil—also referred to as voice coil the magnet coil being situated in a field surrounding the magnet, i.e. the magnetic field of the magnet.

In this embodiment, annular magnet coils having large coil diameters are possible. Such drive coils have large cooling faces and offer ample possibilities of ventilation so that they can be subjected to high loads. Consequently, the coil temperature remains relatively low during use—also in the case of high loads—and only a limited transfer of heat to the other parts such as the permanent magnet of the actuator takes place. This embodiment therefore has a favorable thermal household. It has been found that the temperature of the coil and the magnet remains within acceptable limits, also at higher powers. Modem magnetic materials such as neodymium-iron-boron alloys can therefore be used without any problem.

It is to be noted that a loudspeaker unit is known from WO-A 97/32451, which is provided with a damper fixed to a diaphragm. A coil former with a coil extending in a magnetic gap surrounding a plate on a magnet is fixed to the diaphragm, which gap extends outside the area bounded by the suspensions of the diaphragm. The magnet which is situated at a maximum distance from the diaphragm is fixed to a bottom part of the unit.

In a practical embodiment of the loudspeaker according to the invention, the first flexible connecting means has a flexible structure with an undulation or wrinkle, which is fixed to the chassis at one end and to the translatable body at the other end. In principle, the second flexible connecting means may be formed similarly.

To allow relatively large and accurately defined axial displacements of the translatable body with respect to the chassis, a preferred embodiment of the loudspeaker according to the invention is characterized in that the second flexible connecting means comprises a set of at least three leaf spring elements positioned around the translation axis, each leaf spring element comprising two leaf springs arranged in a slanting position with respect to a plane oriented transversely to the translation axis, the leaf springs of each leaf spring element being each provided with two peripheral parts each extending parallel to said plane, while one of the leaf springs is fixed to the chassis proximate to one of its peripheral parts and the other is fixed to the translatable body proximate to one of its peripheral parts, the leaf springs of each leaf spring element being interconnected proximate to their other peripheral parts. This embodiment of the second flexible connecting means allows a large axial displacement of the diaphragm and is therefore suitable for applications where loudspeakers having a high sound-radiating power are desired.

The flexible connecting device used as the second flexible connecting means described hereinbefore is essentially without friction and guarantees an accurate alignment of the translatable body and hence of the diaphragm with respect to the chassis. Embodiments of this connecting device are described and elucidated in EP-A 1036485 (PHN 16.970, herein incorporated by reference). In this respect, it is only noted that the leaf springs of each leaf spring element are preferably connected or fixed to each other in a mutual undeformable manner at their adjacent peripheral parts. Furthermore, one leaf spring of each leaf spring element is preferably secured in or fixed to the translatable body in an undeformable manner and the other leaf spring is secured in or fixed to the chassis in an undeformable manner by means of one of its peripheral parts.

If desired, the loudspeaker according to the invention may be used as a bandpass loudspeaker for a limited frequency range. This may be achieved in an electrical manner. Notably in low-frequency loudspeakers, the electrical measures to be taken are, however, relatively expensive. A mechanical solution which forms part of the loudspeaker is less expensive and is therefore preferred. A suitable embodiment in this context is characterized in that the translatable actuator element is fixed via a coupling member to the translatable body with a defined bending stiffness and internal damping. The concrete values of the bending stiffness and the damping are determined as a function of the desired frequency range and the characteristics of the loudspeaker. A simulation program may be used for this purpose.

A practical embodiment of the bandpass loudspeaker according to the invention is characterized in that the translatable actuator element comprises a magnet coil arranged on a coil support, the coupling member connecting the coil support to a central portion of the translatable body.

The invention also relates to a loudspeaker unit comprising the electrodynamic loudspeaker according to the invention and also comprising a housing accommodating the loudspeaker. The loudspeaker unit may form part of a compact subwoofer system, in which the loudspeaker or loudspeakers can be subjected to a high load. The loudspeaker according to the invention occupies only a limited space in the housing.

The loudspeaker and loudspeaker unit according to the invention may be successfully used in loudspeaker systems having very flat shapes, possibly combined with panel loudspeakers. Furthermore, applications in which only a limited mounting depth is available are suitable. Particular examples are automotive uses such as, for example, mounting in a car door, in a luggage shelf or below a car seat. High powers of the order of, for example about 150 watts are possible.

It is noted in relation to the claims that various combinations of characteristic features defined in the dependent claims are possible.

These and other aspects of the invention are apparent from and elucidated with reference to the embodiments described hereinafter.

In the drawings:

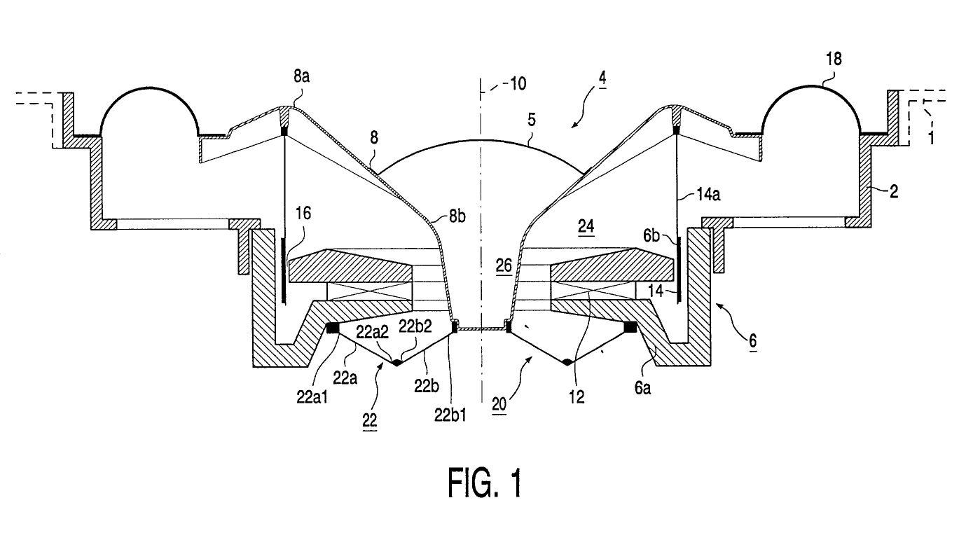

FIG. 1 shows a first embodiment of the loudspeaker according to the invention in a partly diagrammatic cross-section,

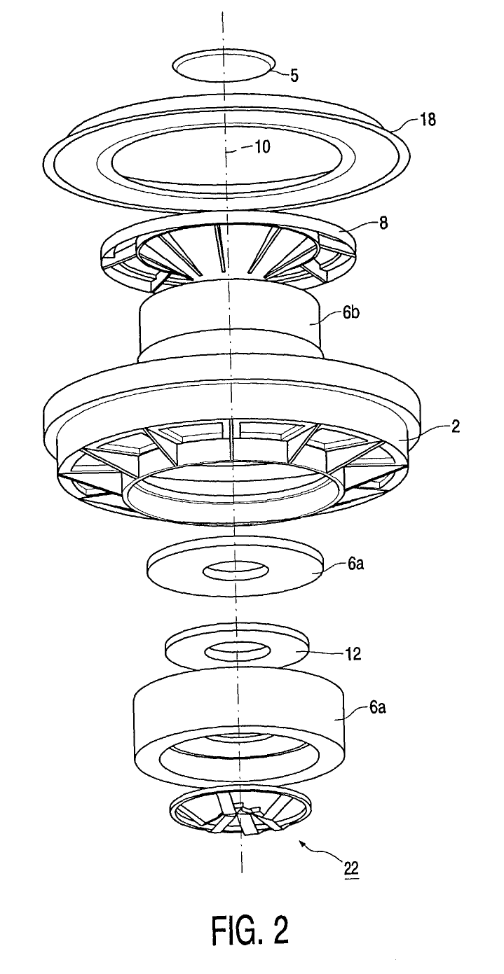

FIG. 2 is a perspective elevational view of the loudspeaker of FIG. 1 in an exploded view,

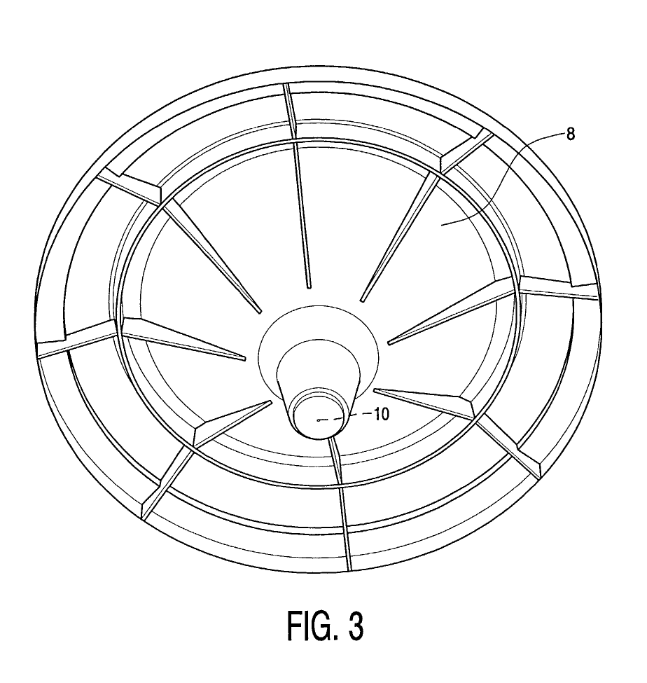

FIG. 3 is a perspective view of a component of the loudspeaker shown in FIGS. 1 and 2,

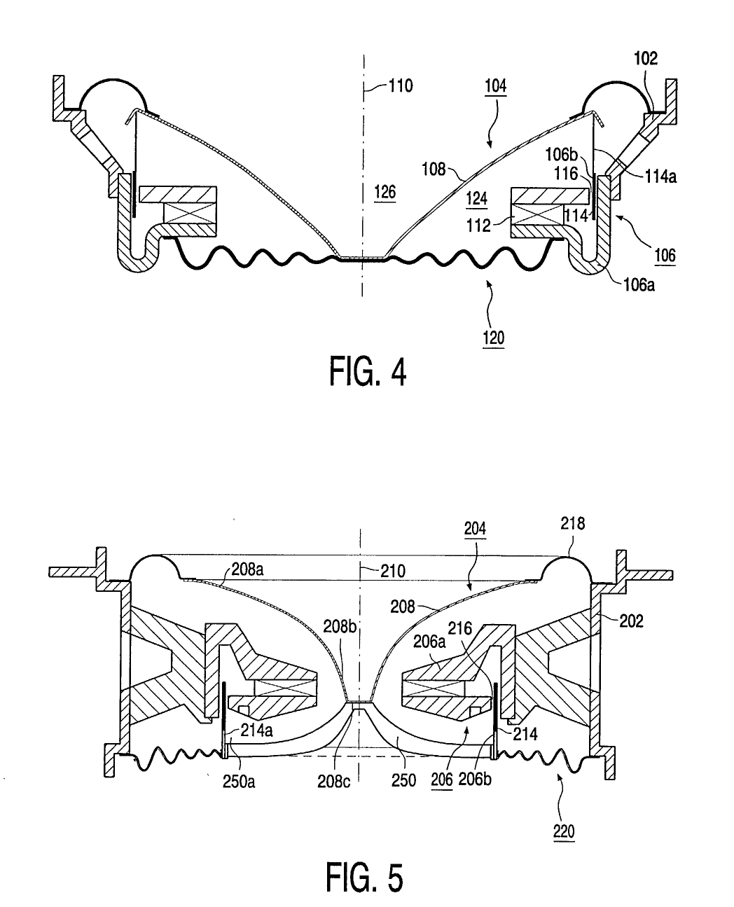

FIG. 4 shows a second embodiment of the loudspeaker according to the invention in a diagrammatic cross-section, and

FIG. 5 shows a third embodiment of the loudspeaker according to the invention in a diagrammatic cross-section.

The electrodynamic loudspeaker according to the invention, shown in FIGS. 1, 2 and 3, comprises a chassis 2, a translatable body 4 and an electromagnetic actuator 6 and is shielded by a dust cover 5. For forming a loudspeaker unit according to the invention, the loudspeaker may be accommodated in a housing. To this end, the chassis 2 of the loudspeaker may be fixed in an appropriate opening in a wall of the housing. In FIG. 1, the housing is shown diagrammatically by means of a wall section 1 in broken lines.

The translatable body 4 comprises a three-dimensional diaphragm 8, in this example a conical diaphragm, which is situated or at least extends in the chassis 2. The diaphragm 8 has a front part 8a and a back part 8b. The function of the electromagnetic actuator 6 is to displace the body 4 along a translation axis 10, being the central axis of the loudspeaker, extending from the front part 8a to the back part 8b, or vice versa. The actuator 6 essentially comprises two elements, namely a stationary actuator element 6a which is fixed to the chassis 2 and a translatable actuator element 6b which is connected to the translatable body 4. One of the actuator elements—in this example the stationary element 6a—is provided with an annular permanent magnet 12 and the other actuator element, in this example the translatable body 6b, is provided with a magnet coil 14, in which, when energizing the coil 14, both actuator elements 6a, 6b magnetically co-operate with each other over an air gap 16 for generating a driving force on the translatable body 4 parallel to the translation axis 10 and hence on the diaphragm 8 forming part thereof. The permanent magnet 12 forms a magnetic yoke with soft iron parts of the stationary actuator element 6a, which yoke defines the air gap 16 in this example. The magnet coil 14, being a cylindrical coil, also referred to as voice coil, is situated on a coil support 14a which is formed as a cylinder in this example and fixed to the translatable body 4.

The loudspeaker according to the invention is provided with a flexible connection for the translatable body 4 and hence for the diaphragm 8. This flexible connection comprises a first flexible connecting means 18 proximate to the front part 8a of the diaphragm 8 and a second flexible connecting means 20 proximate to the back part 8b of the diaphragm 8. The flexible connection is to ensure that the body 4, and particularly the diaphragm 8, can perform well-defined translation movements with respect to the chassis 2.

The first flexible connecting means 18 has a flexible structure formed from, for example, a corrugated rubber annular rim which is secured, for example, glued on its outer circumference to the chassis 2 and on its inner circumference to the translatable body 4. In this example, the second flexible connecting means 20 comprises a set of leaf spring elements 22 positioned around the translation axis 10, in this example six elements. Each leaf spring element 22 has two leaf springs 22a, 22b positioned in a slanting manner transversely to the translation axis 10. Each leaf spring 22a, 22b of each leaf spring element 22 is provided with two peripheral parts (22a1, 22a2; 22b1, 22b2) each extending parallel to said plane, in which the peripheral part 22a1 is fixed to the chassis 2 or, as in this example, is indirectly fixed thereto via the stationary actuator element 6a, the peripheral part 22b1 is fixed to the translatable body 4 and the peripheral parts 22a2 and 22b2 are fixed together. The fixation of a peripheral part to the chassis or to the translatable body, as well as the mutual fixation of the two peripheral parts is rigid. This is favorable for counteracting material fatigue, notably at the location of the fixations.

The loudspeaker according to the invention has a further characteristic feature in that the air gap 16 is present in an area 24 situated between and defined by the first flexible connecting means 18 and the second flexible connecting means 20 and is also situated outside the space 26 enclosed by the diaphragm 8. In this embodiment, the stationary actuator element 6a is largely situated in a zone between the first flexible connecting means 18 and the second flexible connecting means 20, which zone coincides with the above-mentioned area 24. In this example, the annular magnet coil 14 is situated in a magnetic field surrounding the annular permanent magnet 12.

As far as the construction is concerned, the electromagnetic loudspeaker according to the invention shown in FIG. 4 corresponds to a large extent to the loudspeaker already described with reference to FIGS. 1, 2 and 3. An important difference is the flexible connection of the diaphragm, which is simpler in this example and allows the diaphragm to make a movement, i.e. an axial displacement, which is not so large. The loudspeaker has a chassis 102, a body 104 which is translatable along a translation axis 110 and an electromagnetic actuator 106. The body 104 which comprises a conical or otherwise three-dimensional diaphragm 108 is journaled with respect to the chassis 102 via a first flexible connecting means 118 and a second flexible connecting means 120, both in the form of a flexible structure of, for example, rubber, synthetic material and/or textile. In this example, the first flexible connecting means 118 is fixed to the translatable body 104 on the front side of the loudspeaker at one end and to the chassis 102 at the other end. The second flexible connecting means, which is situated on the back part of the loudspeaker, is fixed to the translatable body 104 at one end and to an element 106a fixed to the chassis 102 at the other end.

In principle, the actuator 106 comprises two elements, namely a stationary actuator element, being the above-mentioned element 106a, and an actuator element 106b which is translatable with respect to said element and is fixed to the body 104. The stationary actuator element has a magnetic yoke with a permanent magnet 112 and the translatable actuator element 106b has a voice coil 114 arranged on a coil support 114a, which, upon energization, magnetically co-operates over an air gap 116 with the magnet 112. In order to realize a very flat loudspeaker which can be subjected to a high load, such a construction has been invented that the air gap 116 is situated both outside the space 126 defined by the contours of the diaphragm 108 and within an area 124 situated between the first connecting means 118 and the second connecting means 120.

As regards the location of the air gap, the electromagnetic loudspeaker according to the invention shown in FIG. 5 corresponds to the embodiments already described but has a provision which makes it suitable as a bandpass loudspeaker.

The loudspeaker has a chassis 202, a translatable body 204 with a diaphragm 208 and an electrodynamic actuator 206 which comprises a stationary actuator element 206a fixed to the chassis 202 and a translatable actuator element 206b, which elements can magnetically co-operate with each other over an air gap 216. The body 204 is movably journaled with respect to the chassis 202 along a translation axis 210. A first flexible connecting means 218 and a second flexible connecting means 220, both formed, for example, as described with reference to the example of FIG. 4, are used for this purpose. The first flexible connecting means 218 connects the body 204 to the chassis 202 proximate to the front part 208a of the diaphragm 208. Proximate to a back part 208b of the diaphragm 208, the loudspeaker comprises a coupling member 250 secured to the body 204, which coupling member has a predetermined bending stiffness and a predetermined internal damping both defined by the desired bandpass. In this example, the coupling member is made of a synthetic material and has a flat conical shape. The coupling member 250, which is fixed to the body 204 proximate to a central part 208c of the diaphragm 208 in this example, supports the translatable actuator element 206b on a periphery 250a, particularly a coil support 214a thereof, provided with a magnet coil 214. The second flexible connecting means 220 connects the coupling member 250 to the chassis 202.

It is to be noted that the invention is not limited to the embodiments shown. For example, the embodiments of the flexible connecting means for the translatable body may also be constructed in different suitable manners. Moreover, the loudspeaker unit may not only comprise one or more loudspeakers according to the invention but also one or more bass reflex gates and/or one or more passive radiators. Furthermore, the loudspeakers are not limited to the power of approximately 150 watts mentioned in this document.

1. An electrodynamic loudspeaker comprising a chassis, a translatable body with a three-dimensional diaphragm extending within the chassis, comprising a front part and a back part, and an electromagnetic actuator for displacing said body with respect to the chassis along a translation axis extending from said one part to said other part of the diaphragm, said actuator comprising a stationary actuator element fixed to the chassis and a translatable actuator element connected to the translatable body proximate to the back part of the diaphragm, said actuator elements being capable of magnetically co-operating with each other over an air gap, while a first flexible connecting means is present proximate to the front part of the diaphragm for movably journaling the translatable body with respect to the chassis, and a second flexible connecting means is present proximate to the back part of the diaphragm for movably journaling the translatable body with respect to the chassis, the air gap extending between the stationary actuator element and the translatable actuator element being present outside the space enclosed and defined by the contours of the diaphragm and within an area between the first flexible connecting means and the second flexible connecting means.

2. A loudspeaker as claimed in claim 1, characterized in that the stationary actuator element is at least largely present within a zone situated between the first flexible connecting means and the second flexible connecting means.

3. A loudspeaker as claimed in claim 1, characterized in that the stationary actuator element comprises an annular permanent magnet, and the translatable actuator element comprises a magnet coil, the magnet coil being situated in a field surrounding the magnet.

4. A loudspeaker as claimed in claim 1, characterized in that the first flexible connecting means has a flexible structure with an undulation or wrinkle, which is fixed to the chassis at one end and to the translatable body at the other end.

5. A loudspeaker as claimed in claim 1, characterized in that the second flexible connecting means comprises a set of at least three leaf spring elements positioned around the translation axis, each leaf spring element comprising two leaf springs arranged in a slanting position with respect to a plane oriented transversely to the translation axis, the leaf springs of each leaf spring element being each provided with two peripheral parts each extending parallel to said plane, while one of the leaf springs is fixed to the chassis proximate to one of its peripheral parts and the other is fixed to the translatable body proximate to one of its peripheral parts, the leaf springs of each leaf spring element being interconnected proximate to their other peripheral parts.

6. A loudspeaker as claimed in claim 1, characterized in that the translatable actuator element is fixed via a coupling member to the translatable body with a defined bending stiffness and internal damping.

7. A loudspeaker as claimed in claim 6, characterized in that the translatable actuator element comprises a magnet coil arranged on a coil support, the coupling member connecting the coil support to a central portion of the translatable body.

8. A loudspeaker unit comprising the electrodynamic loudspeaker as claimed in any one of the preceding claims and having a housing accommodating the loudspeaker.
